(19) United States
(12) Patent Application Publication
(10) Pub. No.: US 2009/0255778 A1
(43) Pub. Date: Oct. 15, 2009

(54) APPARATUS FOR, AND METHOD OF, TRANSPORTING ARTICLES VIA CROSSING TRANSPORTING PATHS

(75) Inventor: PETER BERDELLE-HILGE, Konstanz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/423,837

(22) Filed: Apr. 15, 2009

(30) Foreign Application Priority Data
Apr. 15, 2008 (DE) 10 2008 018 937.5

(51) Int. Cl. B65G 37/00

(52) U.S. Cl. 198/358

(57) ABSTRACT

An apparatus and a method are provided for transporting articles via crossing transporting paths. The apparatus contains two processing configurations, a pre-handling configuration, a connecting system, for each processing configuration a respective exit transporting path, for each pre-handling configuration a respective entry transporting path, and for each entry transporting path a respective return path with a start and an end. The return-path start is connected to the associated entry transporting path. The return-path end is connected to at least one of the entry transporting paths. These connections are configured such that the return-path start is disposed downstream of the connecting system and the return-path end is disposed upstream of the connecting system.

### CROSS-REFERENCE TO RELATED APPLICATION

This application claims the priority, under 35 U.S.C. §119, of German application DE 10 2008 018 937.5, filed Apr. 15, 2008; the prior application is herewith incorporated by reference in its entirety.

### BACKGROUND OF THE INVENTION

### Field of the Invention

The invention relates to an apparatus for, and a method of, transporting articles via crossing transporting paths. An apparatus for transporting articles is known from international patent disclosure WO 2006/110486 A2. The apparatus contains at least two processing configurations for processing articles, at least one pre-handling configuration for pre-handling the articles, a connecting system, a respective exit transporting path for each processing configuration, and a respective entry transporting path for each pre-handling configuration. Each of the exit transporting paths is configured for transporting articles from the connecting system to the associated processing configuration. Each of the entry transporting paths is configured for transporting articles from the associated pre-handling configuration to the connecting system. The connecting system connects each entry transporting path to each exit transporting path such that an article can be transported from each pre-handling configuration to each processing configuration. A configuration for pre-sorting items of mail using a plurality of transporting paths is also described in German patent DE 102004056696 B4, corresponding to U.S. patent publication No. 02008/0087582 A1.

### SUMMARY OF THE INVENTION

It is accordingly an object of the invention to provide an apparatus for, and a method of, transporting articles via crossing transporting paths which overcome the above-mentioned disadvantages of the prior art methods and devices of this general type, which prevent the back-up of transported articles in an entry transporting path.

With the foregoing and other objects in view there is provided, in accordance with the invention, an apparatus for processing physical articles. The apparatus contains at least two processing configurations for processing the physical articles, pre-handling configurations for pre-handling the physical articles, a connecting system, and exit transporting paths with a respective one of the exit transporting paths provided for each of the processing configurations. Each of the exit transporting paths transports the physical articles from the connecting system to a respective one of the processing configurations. Entry transporting paths are provided and a respective one of the entry transporting paths is provided for each of the pre-handling configurations. The respective entry transporting path transports the physical articles from a respective one of the pre-handling configurations to the connecting system. The connecting system connects each of the entry transporting paths to each of the exit transporting paths such that an article can be transported from the respective pre-handling configuration to each of the processing configurations. Return-paths are provided and each have a start and an end. A respective one of the return-paths is provided for each of the entry transporting paths. The start of the respective return-path is connected to the respective entry transporting path, and the end of the respective return-path is connected to at least one of the entry transporting paths, such that the start of the respective return-path is disposed downstream of the connecting system and the end of the respective return-path is disposed upstream of the connecting system.

The return path is used, in particular, when the connecting system is completely filled with articles and therefore cannot accommodate any further articles. In this case, the articles are transported past the connecting system to the start of a return path and, via the latter, are transported back to an entry transporting path. This avoids a back-up of articles on the entry transporting path.

The return path preferably leads to an additional entry transporting path. Rather than being connected to a pre-handling configuration, the additional entry transporting path leads from the end of the return path to the connecting system. The additional entry transporting path relieves those entry transporting paths which lead from a pre-handling configuration to the connecting system.

The apparatus according to the solution has at least two processing configurations for processing articles, at least one pre-handling configuration for pre-handling the articles, a connecting system, for each processing configuration a respective exit transporting path, for each pre-handling configuration a respective entry transporting path, and for each entry transporting path a respective return path with a start and an end.

Each exit transporting path is configured for transporting articles from the connecting system to the associated processing configuration. Each entry transporting path is configured for transporting articles from the associated pre-handling configuration to the connecting system. The connecting system connects each entry transporting path to each exit transporting path, to be precise such that an article can be transported from each pre-handling configuration to each processing configuration.

The return-path start is connected to the associated entry transporting path. The return-path end is connected to at least one of the entry transporting paths. These connections are configured such that the return-path start is disposed downstream of the connecting system and the return-path end is disposed upstream of the connecting system.

The apparatus according to the solution avoids back-ups in an entry transporting path. An article which would be involved in the back-up owing to the fact that it cannot be routed into the respective exit transporting path is instead directed into a return path. It is possible for the article to be introduced upstream again into that entry transporting path in which it was already located. It is also possible for the article to be directed, via the return path, into another entry transporting path.

An article is preferably transported to the connecting system via an additional entry transporting path. The entry transporting path is not connected to a pre-handling configuration. Rather, each return path opens out into the additional entry transporting path.

Account is preferably taken, in addition, of the fact that it may not be possible for an article to be processed in a processing configuration, the article being transported to the processing configuration on an exit transporting path. In order to make allowances for this, the article is redirected from the exit transporting path into an additional return path. The additional return path opens out into the additional entry transporting path. An article which cannot be processed by the processing configuration is transported back again from the exit transporting path leading to this processing configuration, via the additional return path and the additional entry transporting path, to the connecting system.

Other features which are considered as characteristic for the invention are set forth in the appended claims.

Although the invention is illustrated and described herein as embodied in an apparatus for, and a method of, transporting articles via crossing transporting paths, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of a sorting installation according to the invention; and

FIG. 2 is a schematic illustration a stack-forming configuration.

### DETAILED DESCRIPTION OF THE INVENTION

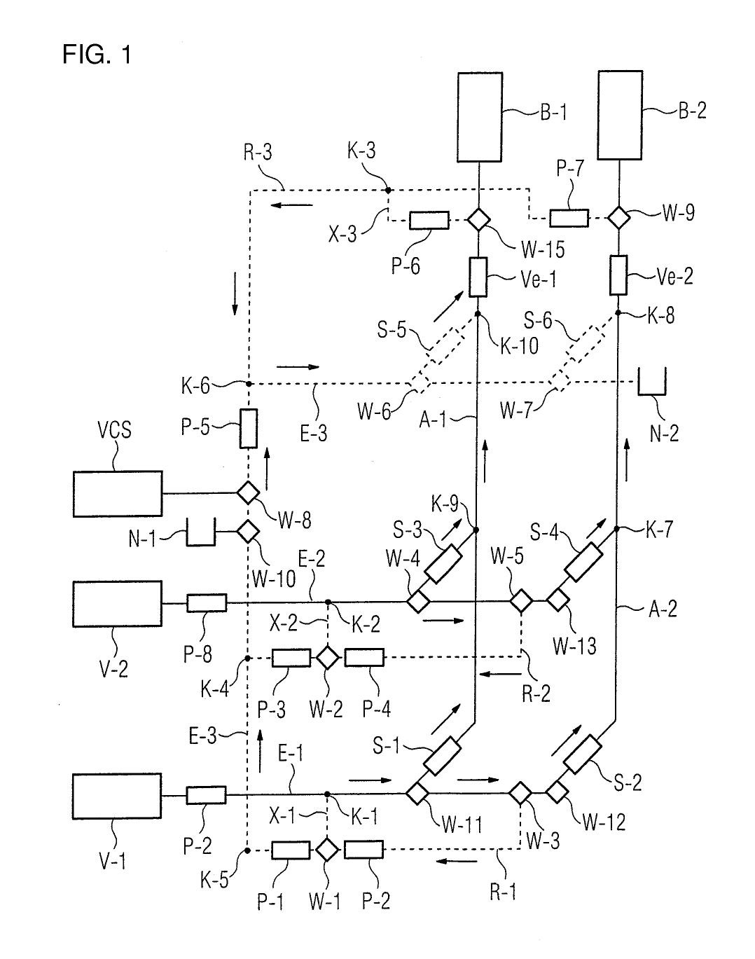

Referring now to the figures of the drawing in detail and first, particularly, to FIG. 1 thereof, there is shown in an exemplary embodiment, articles that are flat items of mail (letters, postcards, periodicals and the like) which are to be transported to predetermined delivery addresses. Each item of mail is provided with details regarding its respective delivery address.

The apparatus, in the exemplary embodiment, is a sorting installation for these items of mail. FIG. 1 shows the sorting installation schematically. The installation includes the following constituent parts: two pre-handling configurations V-1, V-2, two processing configurations B-1, B-2, a plurality of transporting paths, and a multiplicity of output configurations, which are not shown in FIG. 1.

The invention can be used in the same way in a sorting installation having more than two pre-handling configurations or having more than two processing configurations. The sorting installation preferably contains, for each pre-handling configuration, a respective entry transporting path and, for each processing configuration, a respective exit transporting path.

FIG. 1 indicates inlet points using dots and diverters using diamond shapes. Crossing paths are not connected to one another. The direction in which items of mail are transported along a path is indicated by an arrow. Return paths are illustrated by dashed lines, and regularly used transporting paths are indicated by solid lines.

The items of mail are supplied in stacks. Each pre-handling configuration V-1, V-2 carries out the now described steps. It separates out items of mail which are not machine-compatible. It aligns the items of mail of a stack along two edges. It separates the items of mail of the stack transversely to the stacking direction of the flat items of mail, so that separation forms a series of items of mail which are spaced apart from one another.

Each pre-handling configuration V-1, V-2 thus includes so-called input feeders.

Each processing configuration B-1, B-2 carries out the now described steps. It determines the delivery address of each item of mail, e.g. by reading the address by “Optical Character Recognition” (OCR) or by determining the delivery address, which has previously been read and stored, by way of database access. It causes the items of mail to be transported further to that output configuration which is assigned to the delivery address determined.

In an alternative configuration, the sorting installation is used for processing and sorting anew items of mail of which the delivery addresses have already been read. Each pre-handling configuration V-1, V-2 contains, in addition to a separator, a determining device which determines a delivery address which has already been read. For example, the determining device reads, on the item of mail, a bar code which provides coding for the delivery address, or the determining device measures features of the item of mail and determines the stored delivery address with the aid of a method which is known, for example from German patent DE 4000603 C2, as the fingerprint method.

Each processing configuration B-1, B-2 functions as a sorter and contains a number of output configurations. It deflects the items of mail, in dependence on the delivery address determined, into one of its output configurations.

In both configurations, the sorting installation has two entry transporting paths E-1, E-2, two exit transporting paths A-1, A-2, two return paths R-1, R-2 and a connecting system. The entry transporting paths E-1, E-2 lead to the connecting system, and the exit transporting paths A-1, A-2 lead away from the connecting system. The return path R-1 is assigned to the entry transporting path E-1, and the return path R-2 is assigned to the entry transporting path E-2.

The entry transporting path E-1 leads from the pre-handling configuration V-1 to the two exit transporting paths A-1 and A-2. The diverter W-11 optionally deflects an item of mail into the exit transporting path A-1 or leaves it on the entry transporting path E-1. The diverter W-12 deflects an item of mail optionally into the exit transporting path A-2 or into the associated return path R-1.

In the first instance items of mail from the entry transporting path E-1 pass into the exit transporting path A-1. Items of mail from the entry transporting path E-2 pass into the exit transporting path A-1 at the inlet point K-9, and items of mail from the additional entry transporting path E-3 pass into the exit transporting path A-1 at the inlet point K-10. The items of mail then pass through a separator Ve-1, which will be described at a later stage in the text. A diverter W-15 either discharges items of mail into the additional return path R-3, mentioned hereinbelow, from the exit transporting path A-1 or leaves them in the exit transporting path A-1.

The return path R-1 begins downstream of the diverter W-3. In one embodiment, the return path R-1 terminates at the inlet point K-1, that is to say it leads back again to the entry transporting path E-1. In another configuration, the return path R-1 terminates at the inlet point K-2, that is to say it leads to the other entry transporting path E-2.

FIG. 1 shows a preferred embodiment. The apparatus has an additional entry transporting path E-3 for feeding returned items of mail. The additional entry transporting path E-3 is not connected directly to a pre-handling configuration V-1 or V-2. Furthermore, the apparatus contains a connecting path X-1 between the return path R-1 and the entry transporting path E-1.

A diverter W-1 in the return path R-1 either routes a returned item of mail into the connecting path X-1, via which it passes into the entry transporting path E-1, or leaves it on the return path R-1, via which the item of mail passes onto the additional entry transporting path E-3. The return path R-1 thus begins at the diverter W-3 and terminates at the inlet point K-5.

In the example of FIG. 1, the additional entry transporting path E-3 begins at the inlet point K-5. It leads, via the inlet points K-4 and K-6 and the diverter W-6, to the diverter W-7. The return path R-2 opens out into the additional entry transporting path E-3 at the inlet point K-4, and the additional return path R-3, which will be described at a later stage in the text, opens out into this transporting path at the inlet point K-6. The diverter W-6 either introduces an item of mail into the exit transporting path A-1 or leaves the item of mail on the additional entry transporting path E-3. The diverter W-7 either introduces an item of mail into the exit transporting path A-2 or leaves the item of mail on the additional entry transporting path E-3. An item of mail which is not discharged either onto the exit transporting path A-1 or onto the exit transporting path A-2 passes into an output container N-2 (“emergency exit”). This item of mail, then, cannot be processed mechanically or has been misdirected. It is removed from the output container N-2 and processed further by hand.

The sorting installation of FIG. 1 also has an additional return path R-3. Items of mail which have not been separated correctly by upstream separators are returned on the additional return path R-3. These separators include the separators of the pre-handling configurations V-1 and V-2 and the separators Ve-1 and Ve-2 on the two exit transporting paths A-1 and A-2. The additional return path R-3 is arranged downstream to the extent where it is still able to accommodate all these non-separated items of mail before they reach a processing configuration B-1, B-2. The return path begins at the diverter W-9 and leads, via the inlet point K-3, to the inlet point K-6, where the additional return path R-3 opens out into the additional entry transporting path E-3.

The diverter W-15 either routes an item of mail into the additional return path R-3 or leaves the item of mail on the exit transporting path A-1, from where it is transported to the processing configuration B-1.

The entry transporting path E-2 leads from the pre-handling configuration V-2 to the two exit transporting paths A-1 and A-2. The diverter W-4 either deflects an item of mail into the exit transporting path A-1 or leaves it on the entry transporting path E-2. The diverter W-13 deflects an item of mail either into the exit transporting path A-2 or into the associated return path R-2. An item of mail which remains on the entry transporting path E-2, and is not deflected either into the exit transporting path A-1 or into the return path R-2, passes into the exit transporting path A-2 at the inlet point K-7.

The entry transporting path E-2 is assigned the return path R-2, which begins at the diverter W-5 and leads to the inlet point K-4. The diverter W-2 either redirects an item of mail into the connecting path X-2, which leads to the entry transporting path E-2, or leaves the item of mail in the return path R-2. The item of mail passes into the additional entry transporting path E-3 at the inlet point K-4.

In the first instance items of mail from the entry transporting path E-1 pass into the exit transporting path A-2. Items of mail from the entry transporting path E-2 pass into the exit transporting path A-2 at the inlet point K-7, and items of mail from the additional entry transporting path E-3 pass into the exit transporting path A-2 at the inlet point K-8. The items of mail then pass through a separator Ve-2, which will be described at a later stage in the text. A diverter W-9 either discharges items of mail into the additional return path R-3, mentioned hereinbelow, from the exit transporting path A-1 or leaves them in the exit transporting path A-1.

Items of mail which are not machine-compatible or have been misdirected are redirected by a diverter W-10 into the output container N-1 (“emergency exit”). A diverter W-8 redirects items of mail on a connecting path to a further processing unit VCS. In the exemplary embodiment, the diverter W-8 redirects those items of mail on the additional entry transporting path E-3 of which the addresses cannot be deciphered automatically and are therefore read and input manually in a video coding station VCS.

The sorting installation also has various buffer stores. Two buffer stores P-1 and P-2 are located in the return path R-1. The buffer store P-1 is located upstream of the diverter W-1, and the buffer store P-2 is located downstream of the diverter W-1. The buffer store P-1 is thus capable of accommodating both items of mail for the connecting path X-1 and those which remain in the return path R-1. Correspondingly, the return path R-2 contains two buffer stores P-3 and P-4, which are arranged respectively upstream and downstream of the diverter W-2. The two buffer stores P-7 and P-6 are located in the additional return path R-3.

Each transporting path contains a system with pairs of opposite conveying belts or other conveying elements. Each pair of conveying belts is able to clamp in a flat item of mail temporarily between the conveying belts and transport the same in that the opposite conveying belts rotate at the same speed. It is possible for conveying belts of different pairs to rotate at different speeds.

The entry transporting paths E-1, E-2 and the exit transporting paths A-1, A-2 as well as the return paths R-1, R-2 are configured in the manner which has just been described.

In one embodiment, the connecting system contains an endless conveying configuration which is connected to all the entry transporting paths and exit transporting paths. An item of mail is transported from the entry transporting path into the endless conveying configuration and remains in the latter until it has reached an appropriate exit transporting path and the latter can accommodate the item of mail.

In the exemplary embodiment, the connecting system, on the other hand, contains stack-forming configurations. The stack-forming configurations push together in each case a plurality of items of mail from the infeeding entry transporting path to form a small stack and transport the small stack into the respective exit transporting path. The items of mail thus take up less space—as seen in the transporting direction—than if they were transported one behind the other at a distance apart.

FIG. 1 shows the now described stack-forming configurations.

The stack-forming configuration S-1 connects the entry transporting path El to the exit transporting path A-1.

The stack-forming configuration S-2 connects the entry transporting path E-1 to the exit transporting path A-2.

The stack-forming configuration S-3 connects the entry transporting path E-2 to the exit transporting path A-1.

The stack-forming configuration S-4 connects the entry transporting path E-2 to the exit transporting path A-2.

The stack-forming configuration S-5 connects the additional entry transporting path E-3 to the exit transporting path A-1.

The stack-forming configuration S-6 connects the additional entry transporting path E-3 to the exit transporting path A-2.

Correspondingly, the sorting installation of the exemplary embodiment contains a plurality of separators which make each small stack once again into a stream of individual, spaced-apart items of mail. FIG. 1 shows the now described two separators.

The separator Ve-1 (feeder) separates small stacks on the exit transporting path A-1. It is provided downstream of the entry transporting paths E-1 and E-2 and downstream of the additional entry transporting path E-3, in which case it can separate small stacks from the three entry transporting paths E-1, E-2 and E-3. In contrast, it is arranged upstream of the additional return path R-3. This configuration allows items of mail to be returned via the return path R-3 when they have been separated incorrectly by the separator Ve-1 or, for some other reason, are not machine-compatible.

The separator Ve-2 separates small stacks on the exit transporting path A-2. It is likewise arranged downstream of the entry transporting paths E-1, E-2 and E-3 and likewise arranged upstream of the additional return path R-3.

At least two separate items of mail following one after the other run into each stack-forming configuration S-1, S-2, etc. The stack-forming configuration pushes the at least two items of mail over one another such that they at least partially overlap. The at least two overlapping items of mail leave the stack-forming configuration as a first small stack and are transported to the location at which the entry transporting path opens out into the exit transporting path.

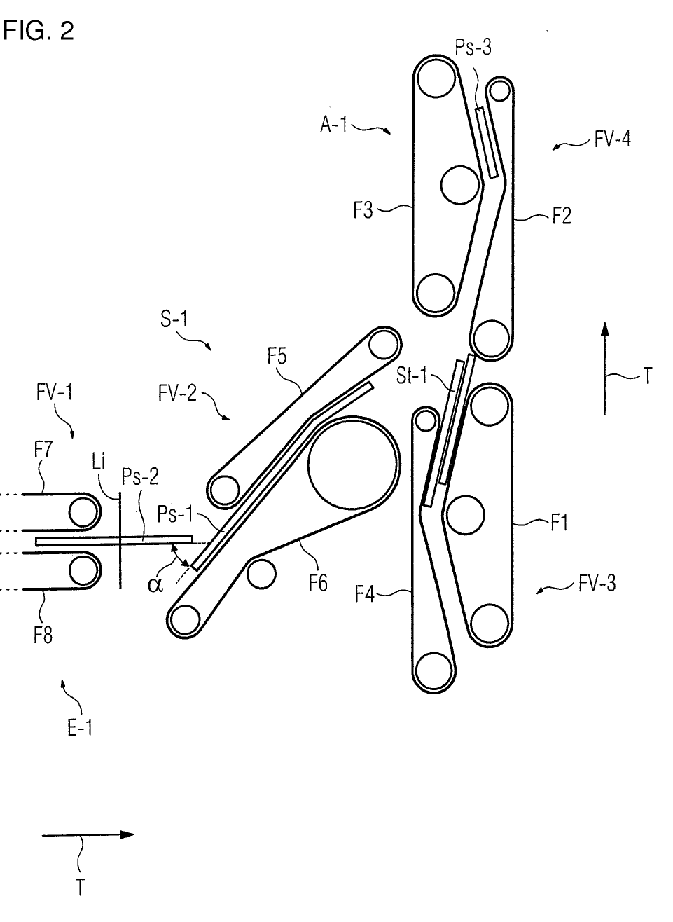

FIG. 2 shows, by way of example, an embodiment of such a stack-forming configuration using the example of S-1, which connects E-1 to A-1. This example shows the following conveying apparatuses: a first conveying apparatus FV-1 with the two driven endless conveying belts F7 and F8; a second conveying apparatus FV-2 with the two driven endless conveying belts F5 and F6; a third conveying apparatus FV-3 with the two driven endless conveying belts F1 and F4; and a fourth conveying apparatus FV-4 with the two driven endless conveying belts F2 and F3.

The first conveying apparatus FV-1 belongs to the entry transporting path E-1 from FIG. 1. The second conveying apparatus FV-2 is a constituent part of the stack-forming configuration S-1. The third conveying apparatus FV-3 and the fourth conveying apparatus FV-4 are located in the exit transporting path A-1.

A series of items of mail is already being transported, preferably in the form of further small stacks, between which a gap occurs in each case, in the exit transporting path A-1. These small stacks come, for example, from other infeeding transporting paths. The first small stack is to be introduced into a gap between items of mail in the exit transporting path A-1. Individual items of mail are also transported in the exit transporting path A-1, for example because they are too thick in order to be combined to form a small stack.

In the example of FIG. 2, a small stack St-1 and a single item of mail Ps-3 are transported in the transporting direction T in the exit transporting path A-1. The two items of mail Ps-1 and Ps-2 are to be combined to form a small stack and introduced between the small stack St-1 and the further item of mail Ps-3. Following introduction, the items of mail are to be transported such that a spacing occurs both between the item of mail Ps-3 and the small stack with the items of mail Ps-1 and Ps-2 and between the small stack and the further small stack St-1.

The length of the first small stack which is to be introduced is determined with the aid of a light barrier Li in the entry transporting path E-1. A further light barrier, which is arranged in the exit transporting path A-1, determines the size of a gap between two successive items of mail or further small stacks in the exit transporting path A-1.

The first small stack is introduced into the gap When its length plus in each case a minimum spacing from the last preceding item of mail and from the first following item of mail is smaller than the gap. Otherwise, preferably the trailing items of mail or further small stacks are transported at a slower speed or even, at times, stopped, whereas the leading items of mail or further small stacks are transported at the same or even, at times, increased speed. This lengthens the gap, in which case the first small stack can be pushed in.

The operation of the stack-forming configuration in the infeeding transporting path will be described in more detail hereinbelow with reference to FIG. 2.

The stack-forming configuration which is shown in FIG. 2 contains the conveying belts F5 and F6 and the rollers around which these two conveying belts F5 and F6 are guided. The infeeding transporting path is formed, inter alia, by the conveying belts F7 and F8. The transporting path opens out into a further transporting path, namely the exit transporting path A-1, which contains the conveying belts F1, F2, F3 and F4 and into which a small stack St-1 is transported.

In one embodiment, the items of mail are deflected as they pass through the stack-forming configuration. The transporting direction in which they are transported is thus modified by an angle a of preferably between 30 degrees and 60 degrees, e.g. it is equal to 45 degrees.

A leading item of mail Ps-1 is transported in the former transporting direction by a first conveying apparatus (endless conveying belt and counterpart conveying element), to be precise until such time as the item of mail Ps-1 is gripped by a second conveying apparatus FV-2. The first conveying apparatus FV-1 contains, in the example of FIG. 2, the conveying belts F7 and F8. A second conveying apparatus FV-2 contains the conveying belts F5 and F6. The second conveying apparatus FV-2 deflects the item of mail Ps-1 through the angle a in to the new conveying direction and continues transporting the item of mail Ps-1 until it is no longer gripped by the first conveying apparatus FV-1 (with F7 and F8). The first conveying apparatus FV-1 then stops or slows down any further transportation of the leading item of mail Ps-1. It is necessary here for the item of mail Ps-1 no longer to be gripped by the first conveying apparatus FV-1 since, otherwise, it would be buckled by the two conveying apparatuses FV-1 and FV-2.

The first conveying apparatus FV-1 transports a following item of mail Ps-2 until it strikes obliquely against the stopped preceding item of mail Ps-1. During the stoppage, the leading item of mail Ps-1 is located—as seen in the former transporting direction—in front of an endless conveying belt F6 of the second conveying apparatus FV-6. Therefore the trailing item of mail Ps-2 cannot warp the stopped, leading item of mail Ps-1 as it strikes against the same; rather, it is deflected because the first conveying apparatus continues to transport the trailing item of mail in the former transporting direction until the second conveying apparatus has gripped the trailing item of mail. The second conveying apparatus grips the leading and the trailing items of mail. These then overlap at least partially. This forms a small stack comprising the leading item of mail Ps-1 and the trailing item of mail Ps-2. The stack-forming configuration transports this small stack away in the new transporting direction, the second conveying apparatus FV-2 continuing to transport the small stack with Ps-1 and Ps-2.

The items of mail are usually rectangular and therefore each have a leading edge—as seen in the transporting direction. The light barrier Li in the entry transporting path E-1 measures the point in time at which the leading edge of the leading item of mail, and the point in time at which that of the trailing item of mail, passes the light barrier Li. The transporting speeds of the two conveying apparatuses FV-1, FV-2 are controlled and are thus likewise known. The second conveying apparatus FV-2 transports the leading item of mail in the new transporting direction to such an extent that the leading edge is located in a defined position when the trailing edge is no longer gripped by the first conveying apparatus. The location at which the leading edge of the trailing item of mail strikes against the stopped, leading item of mail is thus spaced apart from the leading edge of the leading item of mail by a known and adjustable minimum spacing. This spacing is preferably as small as possible, in order that the overall length of the small stack is as small as possible.

The light barrier Li in the entry transporting path E-1 preferably also measures the points in time at which the trailing edges of the two items of mail pass the light barrier Li. The overall length of the small stack which has now been formed is calculated from this information and the transporting speed of the first conveying apparatus FV-1 and the abovementioned spacing between the leading edge of the leading item of mail Ps-1 and the location at which the trailing item of mail strikes against the same.

The sorting installation also has a control configuration, which has reading and writing access to a data memory. The data memory stores, for each item of mail, a respective set of data comprising an internal identifier for the item of mail, the read delivery address and details regarding the current position of the item of mail. The control configuration controls the conveying belts and diverters of the installation in order to direct an item of mail through the sorting installation in dependence on its state and its delivery address.

1. An apparatus for processing physical articles, the apparatus comprising:
at least two processing arrangements for processing the physical articles;
at least one pre-handling arrangement for pre-handling the physical articles;
a connecting system;
exit transportation paths, a respective one of said exit transportation paths provided for each of said processing arrangement, each of said exit transportation paths transporting the physical articles from said connecting system to a respective one of said processing arrangements;
entry transporting paths, a respective one of said entry transporting paths provided for each of said pre-handling arrangement, said respective entry transporting path being configured for transporting the physical articles from a respective one of said pre-handling arrangements to said connecting system;
said connecting system connecting each of said entry transporting paths to each of said exit transportation paths such that an article can be transported from said pre-handling arrangement to each of said processing arrangements; and
return transportation paths each having a start and an end, a respective one of said return transportation paths provided for each of said entry transporting paths, said start of said respective return transportation path connected to said respective entry transporting path, and said end of said respective return transportation path connected to at least one of said entry transporting paths, such that said start of said respective return transportation path is disposed downstream of said connecting system and said end of said respective return transportation path is disposed upstream of said connecting system.

2. The apparatus according to claim 1, further comprising:
an additional entry transporting path for transporting the physical articles to said connecting system; and
said end of each of said return transportation paths runs into said additional entry transporting path upstream of said connecting system.

3. The apparatus according to claim 2, further comprising an additional return transportation path connected to each of said exit transportation paths and said additional entry transporting path configured for transporting the physical articles, said additional return transportation path runs into said additional entry transporting path upstream of said connecting system.

4. The apparatus according to claim 2, wherein said additional entry transporting path has a buffer store disposed downstream of said end of each of said return transportation paths and upstream of said connecting system and by means of which the physical articles which are transported on said additional entry transporting path can be stored on an interim basis.

5. The apparatus according to claim 2, wherein at least one of said return transportation paths has a crossover and a connecting path, said connecting path is connected to a same one of said entry transporting paths as said start of said respective return transportation path, said connecting path runs into said respective entry transporting path downstream of said connecting system and, by means of said crossover, the physical article transported in said respective return transportation path can be directed optionally onto one of said additional entry transporting path and onto said connecting path.

6. The apparatus according to claim 1, wherein each of said return transportation paths has a buffer store by means of which the physical articles which are transported on said respective return transportation path can be stored on an interim basis.

7. The apparatus according to claim 1, wherein:
at least one of said entry transporting paths is configured for transporting the physical articles such that a gap occurs between each pair of two of the physical articles—as seen in a transporting direction;
said connecting system having a crossover and a stack-forming configuration, by means of said crossover, the physical articles can be optionally redirected out of said one entry transporting path into said stack-forming configuration or left in said respective entry transporting path; and
said stack-forming configuration is configured for pushing redirected articles together such that a plurality of the physical articles—as seen perpendicularly to the transporting direction—at least partially overlap, and for transporting overlapping articles into one of said exit transporting paths.

8. The apparatus according to claim 7, further comprising a singulator by means of which the physical articles which are transported in an overlapping state in said respective exit transportation path can be separated such that, following separation, they are spaced apart again.

9. A method of processing physical articles with an aid of an apparatus containing at least two processing arrangements for processing the physical articles, pre-handling arrangements for pre-handling the articles, a connecting system, a respective exit transportation path for each of the processing arrangements, and a respective entry transporting path for each of the pre-handling arrangements, which method comprises the steps of:
selecting one of the processing arrangements for each of the physical articles;
pre-handling each of the physical articles by one of the pre-handling arrangements;
transporting each of the physical articles to a selected processing arrangement via the respective entry transporting path, which is assigned to a respective one of the pre-handling arrangements, the connecting system and the respective exit transportation path assigned to the selected processing arrangement, the connecting system introducing each of the physical articles into the respective exit transportation path from the respective entry transporting path;
providing the respective entry transporting path with a respective return transportation path; and
when it is established that it is currently not possible for an article to be introduced into the respective exit transportation path from the respective entry transporting path, transporting the article into the respective return transportation path and bypassing the connecting system assigned to the respective entry transporting path and in the respective return transportation path, the article is transported to the respective entry transporting path.

10. The method according to claim 9, which further comprises:
providing the apparatus with an additional entry transporting path; and
an article following transportation in the respective return transportation path, is directed into the additional entry transporting path and, in the additional entry transporting path, the article is transported to the connecting system.

11. The method according to claim 10, which further comprises:
providing the apparatus with an additional return path; and
when it is established that the article cannot be processed by selected processing arrangements, the article is discharged from the respective exit transportation path and is transported, via the additional return transportation path, to the additional entry transporting path.
